(19) United States
(12) Patent Application Publication
(10) Pub. No.: US 2005/0058058 A1
(43) Pub. Date: Mar. 17, 2005

(54) Ranging method in a mobile communication system using orthogonal frequency division multiple access

(75) Inventors: Min-Hee Cho, Anyang-si (KR); Bong-Gee Song, Seoul (KR); Sang-Hoon Sung, Suwon-si (KR); Kwang-Seop Eom, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/909,076

(22) Filed: Jul. 30, 2004

(30) Foreign Application Priority Data
Jul. 30, 2003 (KR) P2003-52898

(51) Int. Cl. H04J 11/00

(52) U.S. Cl. 370/208

(57) ABSTRACT

Disclosed is a method for controlling an operational state of at least one subscriber stations in an OFDM/OFDMA communication system having ranging slots and ranging codes to be used for rangings. The subscriber station performing in a Null state, an initial ranging if an initial ranging request occurs, and transitioning from the Null state to an Idle state if the initial ranging is successful; transitioning to an Access state if a bandwidth request ranging request occurs in the Idle state, and performing in the Access state the bandwidth request ranging based on a random access technique; transitioning from the Access state to a Busy state if the random access-based bandwidth request ranging is successful, performing the bandwidth request ranging based on a scheduled access technique if the bandwidth request ranging request occurs in the Busy state, and transmitting data if the scheduled access-based bandwidth request ranging is successful; and transitioning to a Hold state if the data transmission is ended in the Busy state, and performing the scheduled access-based bandwidth request ranging if the bandwidth request ranging request occurs in the Hold state.

### PRIORITY

This application claims priority under 35 U.S.C. § 119 to an application entitled “Ranging Method in a Mobile Communication System Using Orthogonal Frequency Division Multiple Access” filed in the Korean Intellectual Property Office on Jul. 30, 2003 and assigned Ser. No. 2003-52898, the contents of which are incorporated herein by reference.

### BACKGROUND OF THE INVENTION

1. Field of the Invention

The present invention relates generally to a ranging method in a Broadband Wireless Access (BWA) communication system, and in particular, to a ranging method in a communication system supporting an Orthogonal Frequency Division Multiple Access (OFDMA).

2. Description of the Related Art

In a 4^{th} generation (4G) communication system, which is a next generation communication system, active research is being conducted on various technologies for providing the system users with services guaranteeing various qualities of service (QoSs) at a data rate of about 100 Mbps. The current 3^{rd} generation (3G) communication system generally supports a data rate of about 384 Kbps in an outdoor channel environment having a relatively poor channel environment, and supports a data rate of a maximum of 2 Mbps even in an indoor channel environment having a relatively good channel environment. A wireless local area network (LAN) system and a wireless metropolitan area network (MAN) system generally support a data rate of 20 to 50 Mbps. In the current 4G communication system, active research is being carried out on a new communication system securing good mobility and a high QoS for the wireless LAN system and the wireless MAN system supporting a relatively high data rate in order to support the high-speed services that the 4G communication system aims to provide.

FIG. 1 is a diagram illustrating a configuration of a general Broadband Wireless Access (BWA) communication system. Before a description of FIG. 1 is given, it is presumed that the wireless MAN system is a BWA communication system, and covers a broader service area, as well as operates at a higher data rate, as compared with the wireless LAN system. A communication system employing Orthogonal Frequency Division Multiplexing/Orthogonal Frequency Division Multiple Access (OFDM/OFDMA) technology to support a broadband transmission network for a physical channel of the wireless MAN system is referred to as an “IEEE 802.16a communication system.” The IEEE 802.16a communication system corresponds to an OFDM/OFDMA BWA communication system. The IEEE 802.16a communication system, applying the OFDM/OFDMA technology to the wireless MAN system, enables a high-speed data transmission by transmitting a physical channel signal using multiple subcarriers. In addition, the IEEE 802.16e communication system corresponds to a communication system that takes into consideration the mobility of a subscriber station in the IEEE 802.16a communication system. Currently, the specification for the IEEE 802.16e communication system has yet to be developed. Therefore, both the IEEE 802.16a communication system and the IEEE 802.16e communication system correspond to the OFDM/OFDMA BWA communication system, and for the sake of convenience, the IEEE 802.16a and IEEE 802.16e OFDM/OFDMA communication systems will be described herein below. Although the IEEE 802.16a communication system and the IEEE 802.16e communication system can employ a Single Carrier instead of the OFDM/OFDMA technology, it will be assumed herein that the OFDM/OFDMA technology is employed.

Referring to FIG. 1, the IEEE 802.16a/IEEE 802.16e communication system has a multicell configuration, and is comprised of a base station 100 and a plurality of subscriber stations 110, 120 and 130, all of which are managed by the base station 100. Signal exchange between the base station 100 and the subscriber stations 110, 120 and 130 is achieved using the OFDM/OFDMA technology.

The OFDMA technology can be defined as a two-dimensional access method which is a combination of Time Division Access (TDA) and Frequency Division Access (FDA). Therefore, when data is transmitted by OFDMA technology, the OFDMA symbols are separately carried by subcarriers and transmitted over predetermined subchannels. The “subchannel” is a channel comprised of a plurality of subcarriers, and in a communication system supporting OFDMA technology (hereinafter referred to as an “OFDMA communication system”), each subchannel is comprised of a predetermined number of subcarriers according to system conditions. With reference to FIG. 2, a description will now be made of a frame configuration of the OFDMA communication system.

FIG. 2 is a diagram illustrating a frame configuration of an OFDMA communication system. Referring to FIG. 2, the horizontal axis represents OFDMA symbol numbers, while the vertical axis represents subchannel numbers. As illustrated in FIG. 2, one OFDMA frame is comprised of a plurality of, for example 8, OFDMA symbols, and each OFDMA symbol is comprised of a plurality of, for example N, subchannels. Further, each OFDMA frame includes a plurality of, for example 4, ranging slots. Reference numeral 211 represents ranging regions, or ranging slots, existing in an M^{th} frame, and reference numeral 221 represents ranging slots existing in an (M+1)^{th} frame.

A ranging channel is comprised of one or more subchannels, and unique number of subchannels constituting the ranging channel are included in an uplink (UL)-MAP message. Here, the ranging channel is a logical channel using ranging regions in a frame, and Initial Ranging, Periodic Ranging and Bandwidth Request Ranging are performed through the ranging channel. The ranging slots are provided by dividing the ranging channel in a time axis, and the ranging slots are classified into initial ranging slots, periodic ranging slots, and bandwidth request ranging slots. The UL-MAP message is a message representing uplink frame information, and includes an ‘Uplink Channel ID’ representing an uplink channel identifier (ID) in use, a ‘UCD Count’ representing a count corresponding to a change in the configuration of an Uplink Channel Descript (UCD) message having an uplink burst profile, and a ‘Number of UL-MAP Elements n’ representing the number of elements following the UCD Count. The uplink channel identifier is uniquely allocated in a Media Access Control (MAC) sublayer.

That is, the OFDMA communication system aims at distributing all of the subcarriers used therein, in particular data subcarriers, over the entire frequency band, to thereby acquire a frequency diversity gain.

In addition, the OFDMA communication system needs a ranging process for adjusting a correct time offset to a transmission side, or a base station, and a reception side, or a subscriber station, and for controlling power.

The rangings can be classified into the following three rangings according to their objects.

1. Initial Ranging

2. Bandwidth Request Ranging

3. Periodic Ranging (or Maintenance Ranging)

Objects of the three rangings are defined in the IEEE 802.16a communication system.

The IEEE 802.16a communication system, because it employs OFDM/OFDMA technology, needs ranging subchannels and ranging codes for the ranging procedure, and a base station allocates the allowable ranging codes according to the objects, or types, of rangings. This will be described in detail herein below.

The ranging code is generated by segmenting a pseudo-random noise (PN) sequence having a predetermined length of, for example (2¹⁵-1) bits, on a predetermined unit basis. Generally, two ranging subchannels having a length of 53 bits constitute one ranging channel, and a PN code is segmented through a ranging channel having a length of 106 bits to generate the ranging codes. Of the configured ranging codes, a maximum of 48 ranging codes RC#1 to RC#48 can be allocated to the subscriber stations, and as a default value, a minimum of 2 ranging codes per subscriber station are applied to the rangings of the 3 objects, i.e. initial ranging, periodic ranging and bandwidth request ranging. In this way, the different ranging codes are separately allocated to the rangings of the 3 objects. For example, N ranging codes are allocated for the initial ranging (N RCs (Ranging Codes) for initial ranging), M ranging codes are allocated for the periodic ranging (M RCs for maintenance ranging), and L ranging codes are allocated for the bandwidth request ranging (L RCs for BW-request ranging). The allocated ranging codes, as described above, are transmitted to the subscriber stations through a UCD message, and the subscriber stations perform a ranging procedure by using the ranging codes included in the UCD message according to their objects.

FIG. 3 is a diagram illustrating a structure of a ranging code generator for generating ranging codes in a general OFDMA communication system. Referring to FIG. 3, the ranging codes are generated by segmenting a PN sequence having a predetermined length on a predetermined unit basis as described above. Shown in FIG. 3 is a PN sequence generator, or a ranging code generator, having a generation polynomial of 1+x¹+x⁴+x⁷+x¹⁵.

The ranging code generator is comprised of a plurality of memories 510 mapped to respective terms of the generation polynomial, and an exclusive OR (XOR) operator 520 for performing an XOR operation on the values output from the memories 510 corresponding to respective taps of the generation polynomial.

In the OFDMA communication system, as described above, one ranging channel is comprised of two ranging subchannels, each subchannel is comprised of 53 subcarriers, and 106-bit ranging codes are used. Each subscriber station randomly selects any one of the ranging codes, and performs a ranging procedure using the randomly selected ranging code. The ranging code is modulated for the subcarriers in the ranging channel on a bit-by-bit basis by Binary Phase Shift Keying (BPSK) before being transmitted. Therefore, the ranging codes have a characteristic having no correlation between them, so that even though the ranging codes are transmitted at the same time, a receiver can distinguish the ranging codes.

Now, a description will be made of the three kinds of rangings, i.e. the Initial Ranging, the Bandwidth Request Ranging, and the Periodic Ranging.

1. Initial Ranging

The initial ranging acquires the synchronization with a subscriber station by a base station at the request of the base station. The initial ranging is performed to adjust the correct time and frequency offsets between the subscriber station and the base station and to adjust the transmission power. That is, the subscriber station receives a DL-MAP message and a UL-MAP/UCD message upon power-on to acquire the synchronization with the base station, and then performs the initial ranging in order to adjust the time offset with the base station and the transmission power. The base station receives a MAC address of the subscriber station from the subscriber station through the initial ranging procedure. The base station generates a basic connection ID (CID) mapped to the MAC address of the subscriber station, and a primary management CID, and transmits the generated basic CID and primary management CID to the subscriber station. The subscriber station recognizes its own basic CID and primary management CID through the initial ranging procedure.

FIG. 4 is a flow diagram illustrating an initial ranging procedure in a general OFDMA communication system. With reference to FIG. 4, a description will be made of an initial ranging procedure in an OFDMA communication system based on Code Division Multiple Access (CDMA) technology. Referring to FIG. 4, a subscriber station 450, upon power-on, monitors all frequency bands previously set in the subscriber station (SS) 450, and detects a pilot channel signal having highest power, i.e. a highest carrier to interference and noise ratio (CINR). The subscriber station 450 determines a base station 400 that transmitted a pilot channel signal having the highest CINR as its base station to which it currently belongs, and acquires a system synchronization with the base station 400 by receiving a preamble of a downlink frame transmitted from the base station 400.

If the system synchronization between the subscriber station 450 and the base station 400 is acquired in this way, the base station 400 transmits a DL-MAP message to the subscriber station 450 (Step 411). The DL-MAP message includes a ‘PHY Synchronization’ being set according to a modulation scheme and a demodulation scheme employed for a physical (PHY) channel for acquiring the synchronization, a ‘DCD Count’ representing a count corresponding to a change in the configuration of a DCD message including a downlink burst profile, a ‘Base Station ID’ representing a Base Station Identifier (BSID), a ‘Number of DL-MAP Elements n’ representing the number of elements following the Base Station ID, and information related to the ranging codes separately allocated to the rangings.

After transmitting the DL-MAP message, the base station 400 transmits a UCD message to the subscriber station 450 (Step 413). The UCD message includes an ‘Uplink Channel ID’ representing an uplink channel ID in use, a ‘Configuration Change Count’ counted in a base station, a ‘Mini-slot Size’ representing a size of mini-slots in an uplink physical channel, a ‘Ranging Backoff Start’ representing a start point of a backoff for initial ranging, i.e. representing a size of an initial backoff window for initial ranging, a ‘Ranging Backoff End’ representing an end point of a backoff for initial ranging, i.e. representing a size of a final backoff window, a ‘Request Backoff Start’ representing a start point of a backoff for contention data and requests, i.e. representing a size of an initial backoff window, and a ‘Request Backoff End’ representing an end point of a backoff for contention data and requests, i.e. representing a size of a final backoff window. Here, the Request Backoff Start corresponds to a MIN_WIN representing a minimum window size for an exponential random backoff algorithm described herein below, and a Request Backoff End corresponds to a MAX_WIN representing a maximum window size for the exponential random backoff algorithm. The exponential random backoff algorithm will be described below. The backoff value represents a type of a waiting time for which a subscriber station should wait for a next ranging when it failed in rangings described below. When the subscriber station fails in ranging, the base station must transmit to the subscriber station the backoff value which is the information on a time for which it must wait for a next ranging. If it is assumed that a backoff value for a case where the subscriber station fails in ranging is k, the subscriber station transmits a next ranging code after waiting for a ranging slot by a value randomly selected from [1,2^{k}]. The backoff value k is increased up to the Ranging Backoff End value from the Ranging Backoff Start value on a one-by-one basis each time a ranging attempt is made.

After transmitting the UCD message, the base station 400 transmits a UL-MAP message to the subscriber station 450 (Step 415). Upon receiving the UL-MAP message from the base station 400, the subscriber station 450 can recognize the ranging codes used for the initial ranging, the information on a modulation scheme and a demodulation scheme, a ranging channel, and a ranging slot. The subscriber station 450 randomly selects one ranging code from the ranging codes used for the initial ranging, randomly selects one ranging slot from the ranging slots used for the initial ranging, and then transmits the selected ranging code to the base station 400 through the selected ranging slot (Step 417). The transmission power used for the transmitting of the ranging code in step 417 has a minimum transmission power level.

If the subscriber station 450 fails to receive a separate response from the base station 400 even though it transmitted the ranging code, the subscriber station 450 once again randomly selects one ranging code from the ranging codes used for the initial ranging, randomly selects one ranging slot from the ranging slots used for the initial ranging, and then transmits the selected ranging code to the base station 400 through the selected ranging slot (Step 419). The transmission power used for transmitting the ranging code in step 419 is higher in a power level than the transmission power used for transmitting the ranging code in step 417. Of course, if the subscriber station 450 receives from the base station 400 a response to the ranging code transmitted in step 417, step 419 can be skipped.

Upon receiving a random ranging code through a random ranging slot from the subscriber station 450, the base station 400 transmits to the subscriber station 450 a ranging response (RNG-RSP) message including information indicating the successful receipt of the ranging code, for example an OFDMA symbol number, a subchannel and a ranging code (Step 421). Though not illustrated herein, upon receiving the RNG-RSP message, the subscriber station 450 adjusts the time and the frequency offsets and the transmission power using the information included in the RNG-RSP message. In addition, the base station 400 transmits a UL-MAP message including the CDMA Allocation IE for the subscriber station 450 to the subscriber station 450 (Step 423). The CDMA Allocation IE includes information on an uplink bandwidth at which the subscriber station 450 will transmit a ranging request (RNG-REQ) message.

The subscriber station 450 receiving the UL-MAP message from the base station 400 detects the CDMA Allocation IE included in the UL-MAP message, and transmits an RNG-REQ message including a MAC address to the base station 400 using an uplink resource, or the uplink bandwidth, included in the CDMA Allocation IE (Step 425). The base station 400 receiving the RNG-REQ message from the subscriber station 450 transmits an RNG-RSP message including connection IDs (CIDs), i.e. a basic CID and a primary management CID, to the subscriber station 450 according to a MAC address of the subscriber station 450 (Step 427).

After performing the initial ranging procedure in the manner described in conjunction with FIG. 4, the subscriber station can recognize a basic CID and a primary management CID uniquely allocated thereto. Further, in the initial ranging procedure, because the subscriber station randomly selects a ranging slot and a ranging code and transmits the randomly selected ranging code for the randomly selected ranging slot, there is a case where the same ranging codes transmitted by different subscriber stations collide with each other at one ranging slot. When the ranging codes collide with each other in this way, the base station cannot identify the collided ranging codes, and thus cannot transmit the RNG-RSP message. In addition, because the RNG-RSP message cannot be received from the base station, the subscriber station repeats the transmission of a ranging code for the initial ranging after waiting for a backoff value corresponding to the exponential random backoff algorithm.

The exponential random backoff algorithm will be described in detailed herein below.

If a minimum window size and a maximum window size used in the exponential random backoff algorithm are defined as MIM_WIN and MAX_WIN, respectively, the subscriber station randomly selects one ranging slot from among 2^{MIN}^{_{—}}^{WIN} ranging slots during the first ranging code transmission, and transmits a ranging code for the selected ranging slot. If a ranging code collision occurs during the first ranging code transmission, the subscriber station randomly selects one ranging slot again from among the following (2^{MIN}^{_{—}}^{WIN+1}) ranging slots from the corresponding ranging slot during the second ranging code transmission, and transmits a ranging code for the selected ranging slot. If ranging code collision occurs during the second ranging code transmission, the subscriber station again randomly selects one ranging slot from among the following (2^{MIN}^{_{—}}^{WIN+2}) ranging slots from the corresponding ranging slot during the third ranging code transmission, and transmits a ranging code for the selected ranging slot. In this way, when a subscriber station randomly selects one ranging slot from the 2^{k} ranging slots, the ‘k’ is defined as a window size. The window size k used during the ranging code retransmission process is increased one by one from MIN_WIN until the ranging code transmission is successful, i.e. until an RNG-RSP message is received, and window size k is increased until it reaches the maximum window size MAX_WIN.

2. Periodic Ranging

The periodic ranging represents ranging periodically performed to adjust a channel status with a base station by a subscriber station that adjusted a time offset with the base station and the transmission power through the initial ranging. The subscriber station performs the periodic ranging using the ranging codes allocated for the periodic ranging.

3. Bandwidth Request Ranging

The bandwidth request ranging is ranging used to request the bandwidth allocation to actually perform a communication with a base station by a subscriber station that adjusted a time offset with the base station and the transmission power through the initial ranging.

FIG. 5 is a flow diagram illustrating a bandwidth request ranging procedure in a general OFDMA communication system based on CDMA technology. Referring to FIG. 5, a subscriber station 550 randomly selects one ranging code from among the ranging codes used for the bandwidth request ranging, randomly selects one ranging slot from among the ranging slots used for the bandwidth request ranging, and then transmits the selected ranging code to a base station 500 through the selected ranging slot (Step 511). If the subscriber station 550 fails to receive a separate response from the base station 500 even though it transmitted the ranging code, the subscriber station 550 once again randomly selects one ranging code from the ranging codes used for the initial ranging, randomly selects one ranging slot from the ranging slots used for the bandwidth request ranging, and then transmits the selected ranging code to the base station 500 through the selected ranging slot (Steps 513 and 515). Of course, if the subscriber station 550 receives from the base station 500 a response to the ranging code transmitted in Step 511, the steps 513 and 515 are skipped.

Upon receiving a random ranging code through a random ranging slot from the subscriber station 550, the base station 500 transmits a UL-MAP message including the CDMA Allocation IE to the subscriber station 550 (Step 517). The CDMA Allocation IE includes information related to an uplink bandwidth at which the subscriber station 550 will transmit a bandwidth request (BW-REQ) message. The subscriber station 550 receiving the UL-MAP message from the base station 500 detects the CDMA Allocation IE included in the UL-MAP message, and transmits a BW-REQ message to the base station 500 using an uplink resource, or the uplink bandwidth, included in the CDMA Allocation IE (Step 519). The base station 500 receiving the BW-REQ message from the subscriber station 550 allocates an uplink bandwidth for data transmission by the subscriber station 550. Further, the base station 500 transmits to the subscriber station 550 a UL-MAP message including the information related to the uplink bandwidth allocated for the data transmission by the subscriber station 550 (Step 521). The subscriber station 550 receiving the UL-MAP message from the base station 500 recognizes the uplink bandwidth allocated for data transmission, and transits data to the base station 500 through the uplink bandwidth (Step 523).

After performing the bandwidth request ranging procedure in the manner described in conjunction with FIG. 5, the subscriber station can transmit data to the base station. In the bandwidth request ranging procedure, as described in the initial ranging procedure, because the subscriber station randomly selects a ranging slot and a ranging code and transmits the randomly selected ranging code for the randomly selected ranging slot, there is a case where the same ranging codes transmitted by different subscriber stations collide with each other at one ranging slot. When the ranging codes collide with each other in this way, the base station cannot identify the collided ranging codes, and thus cannot allocate an uplink bandwidth. In addition, because the subscriber station cannot be allocated an uplink bandwidth from the base station, the subscriber station repeats the transmission of a ranging code for the bandwidth request ranging after waiting for a backoff value corresponding to the exponential random backoff algorithm.

FIG. 6 is a diagram illustrating a backoff procedure during initial ranging, periodic ranging, and bandwidth request ranging in a general OFDMA communication system. Before a description of FIG. 6 is given, it should be noted that although the backoff procedure of FIG. 6 can be applied to each of the initial ranging procedure, the periodic ranging procedure, and the bandwidth request ranging procedure, the backoff procedure will be applied herein to the initial ranging procedure for the convenience of explanation.

Referring to FIG. 6, one frame is comprised of L ranging slots for an initial ranging. First, a first frame will be described. Three subscriber stations transmit ranging codes at a 3^{rd} ranging slot from among the L ranging slots, and the three subscriber stations transmit the ranging codes at an L^{th} ranging slot. Here, the three subscriber stations transmitting ranging codes at the 3^{rd} ranging slot will be referred to as a first subscriber station, a second subscriber station, and a third subscriber station, respectively. Further, the three subscriber stations transmitting ranging codes at the L^{th} ranging slot will be referred to as a fourth subscriber station, a fifth subscriber station, and a sixth subscriber station, respectively.

At the 3^{rd} ranging slot, the first subscriber station transmits a ranging code #1, and the second and third subscriber stations transmit ranging codes #2. In this way, when the ranging codes are transmitted using the same ranging codes, i.e. the ranging codes #2, at the same ranging slot, the ranging codes #2 collide with each other, so the base station cannot recognize the ranging codes #2. As described above, data transmitted by a plurality of the subscriber stations at the same slot (or same time) can be distinguished by the ranging codes (for example, PN codes). However, if different subscriber stations transmit data using the same code at the same time, the base station cannot distinguish the data transmitted by the individual subscriber stations. Therefore, the second subscriber station and the third subscriber station cannot receive separate responses from the base station, and perform a backoff according to the exponential random backoff algorithm. That is, the second subscriber station transmits a ranging code using a ranging code #3 at a 4^{th} ranging slot of a second frame, and the third subscriber station transmits a ranging code using the ranging code #2 again at a 2^{nd} ranging slot of the second frame.

At the L^{th} ranging slot, the fourth subscriber station and the fifth subscriber station transmits the ranging codes #1, and the sixth subscriber station transmits a ranging code #3. In this way, when ranging codes are transmitted using the same ranging codes, i.e., the ranging codes #1, at the same ranging slot, the ranging codes #1 collide with each other, so the base station cannot recognize the ranging codes #1. Therefore, the fourth subscriber station and the fifth subscriber station cannot receive separate responses from the base station, and perform backoff according to the exponential random backoff algorithm. Although backoffs for the fourth subscriber station and the fifth subscriber station are not separately illustrated in FIG. 6, they are identical in their operation to the backoffs for the second subscriber station and the third subscriber station.

In the OFDMA communication system, a subscriber station randomly selects ranging slots and ranging codes for an initial ranging, a periodic ranging and a bandwidth request ranging during the initial ranging, the periodic ranging and the bandwidth request ranging, thereby causing frequent occurrences of ranging code collisions. The occurrences of the ranging code collisions prevents the base station from recognizing a ranging code for the subscriber station, so the base station cannot perform an operation any longer. Although the subscriber station performs a backoff procedure according to the exponential random backoff algorithm due to the ranging code collision, the transmission of a ranging code by the backoff may also cause further collisions, leading to an access delay to the base station by the subscriber station. The access delay causes a performance degradation of the OFDMA communication system.

### SUMMARY OF THE INVENTION

It is, therefore, an object of the present invention to provide a bandwidth request ranging method for minimizing an access delay in an OFDMA communication system.

It is another object of the present invention to provide a bandwidth request ranging method for preventing ranging code collision in an OFDMA communication system.

It is further another object of the present invention to provide a method for adaptively performing bandwidth request ranging according to a state of a subscriber station in an OFDMA communication system.

In accordance with one aspect of the present invention, there is provided a method for controlling an operational state of at least one subscriber station in an Orthogonal Frequency Division Multiplexing/Orthogonal Frequency Division Multiple Access (OFDM/OFDMA) mobile communication system having ranging slots and ranging codes to be used for rangings. In the method, the subscriber station performs an initial ranging if an initial ranging request occurs in a Null state, and transitions from the Null state to an Idle state if the initial ranging is successful; transitions to an Access state if a bandwidth request ranging request occurs in the Idle state, and performs the bandwidth request ranging based on a random access technique in the Access state; transitions from the Access state to a Busy state if the random access-based bandwidth request ranging is successful, performs the bandwidth request ranging based on a scheduled access technique if the bandwidth request ranging request occurs in the Busy state, and transmits data if the scheduled access-based bandwidth request ranging is successful; and transitions to a Hold state if the data transmission is ended in the Busy state, and performs the scheduled access-based bandwidth request ranging if the bandwidth request ranging request occurs in the Hold state.

In accordance with another aspect of the present invention, there is provided a ranging method for minimizing an access delay of subscriber stations and preventing ranging code collision in a mobile communication system having ranging slots and ranging codes to be used for rangings, the rangings between a base station and a subscriber station being classified into an initial ranging, a bandwidth request ranging and a periodic ranging. In the ranging method, the subscriber station performs the initial ranging with the base station; performs the bandwidth request ranging based on a random access technique with the base station if the initial ranging is successful; and performs the bandwidth request ranging based on a scheduled access technique with the base station if the random access-based bandwidth request ranging is successful.

In accordance with further another aspect of the present invention, there is provided a ranging method for minimizing an access delay of subscriber stations and preventing a ranging code collision in a mobile communication system having ranging slots and ranging codes to be used for rangings, the rangings between a base station and a subscriber station being classified into an initial ranging, a bandwidth request ranging and a periodic ranging. In the ranging method, the base station generates a number of groups equal to the number of ranging slots allocated for bandwidth request ranging based on a scheduled access technique from among the ranging slots for the bandwidth request ranging, and allocates the ranging codes such that ranging codes for the bandwidth request ranging are not duplicated in each of the groups. The subscriber station performs the initial ranging with the base station. The subscriber station selects a random ranging slot from among the ranging slots allocated for the bandwidth request ranging based on a random access technique in the ranging slots for the bandwidth request ranging if the initial ranging is successful, and selects a random ranging code from among the ranging codes for the bandwidth request ranging. The subscriber station performs the random access-based bandwidth request ranging at the selected ranging slot using the selected ranging code. The base station selects a random group from among the groups if the random access-based bandwidth request ranging by the subscriber station is successful, selects a random ranging code from among the ranging codes in the selected group, and transmits a group identifier (ID) corresponding to the selected group and the selected ranging code to the subscriber station. The subscriber station performs the scheduled access-based bandwidth request ranging at a ranging slot corresponding to the group ID using the selected ranging code.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a configuration of a general Broadband Wireless Access (BWA) communication system;

FIG. 2 is a diagram illustrating a frame configuration of an OFDMA communication system;

FIG. 3 is a diagram illustrating a structure of a ranging code generator in a general OFDMA communication system;

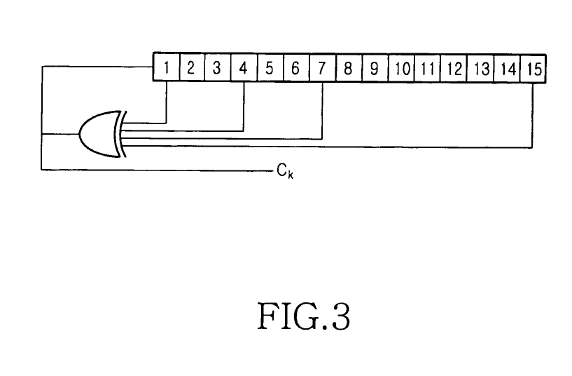

FIG. 4 is a flow diagram illustrating an initial ranging procedure in a general OFDMA communication system;

FIG. 5 is a flow diagram illustrating a bandwidth request ranging procedure in a general OFDMA communication system;

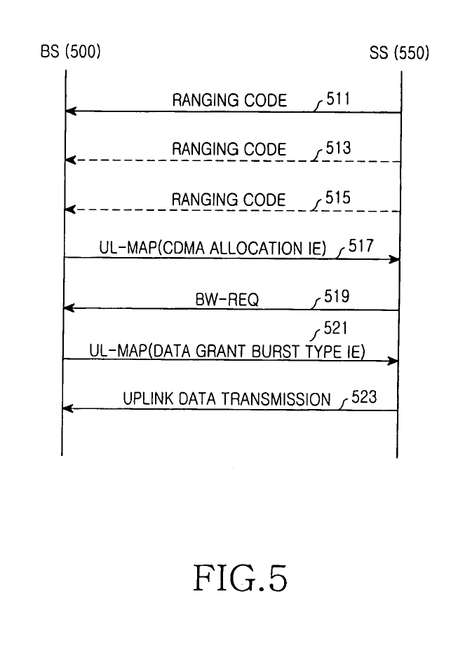

FIG. 6 is a diagram illustrating a backoff procedure during initial ranging and bandwidth request ranging in a general OFDMA communication system;

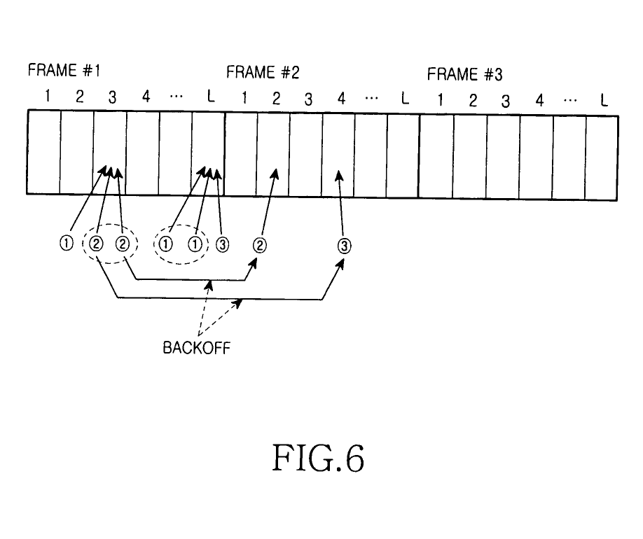

FIG. 7 is a diagram illustrating a ranging region configuration for an OFDMA communication system according to an embodiment of the present invention;

FIG. 8 is a diagram illustrating a state diagram of a subscriber station according to an embodiment of the present invention; and

FIG. 9 is a flowchart illustrating a ranging procedure in an OFDMA communication system according to an embodiment of the present invention.

### DETAILED DESCRIPTION OF THE PREFERRED EMBODIMENT

A preferred embodiment of the present invention will now be described in detail with reference to the annexed drawings. In the following description, a detailed description of known functions and configurations incorporated herein has been omitted for conciseness.

The present invention provides a bandwidth request ranging method for preventing ranging code collision while minimizing an access delay in a communication system supporting Orthogonal Frequency Division Multiple Access (OFDMA) technology (hereinafter referred to as “OFDMA communication system”). In addition, the present invention proposes an operational state of a Media Access Control (MAC) layer of a subscriber station (SS) for performing a bandwidth request ranging without the ranging code collision while minimizing an access delay time.

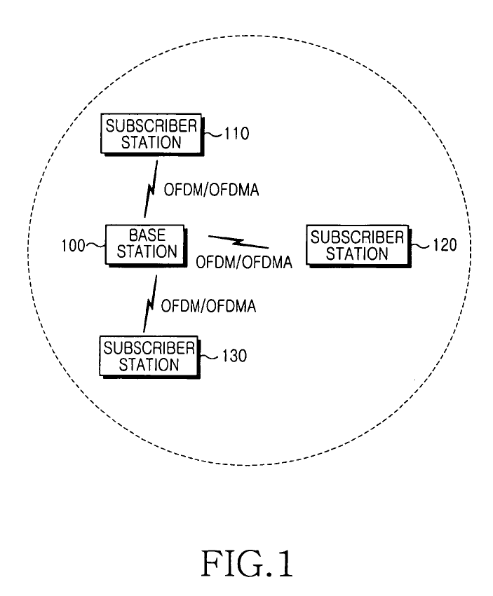

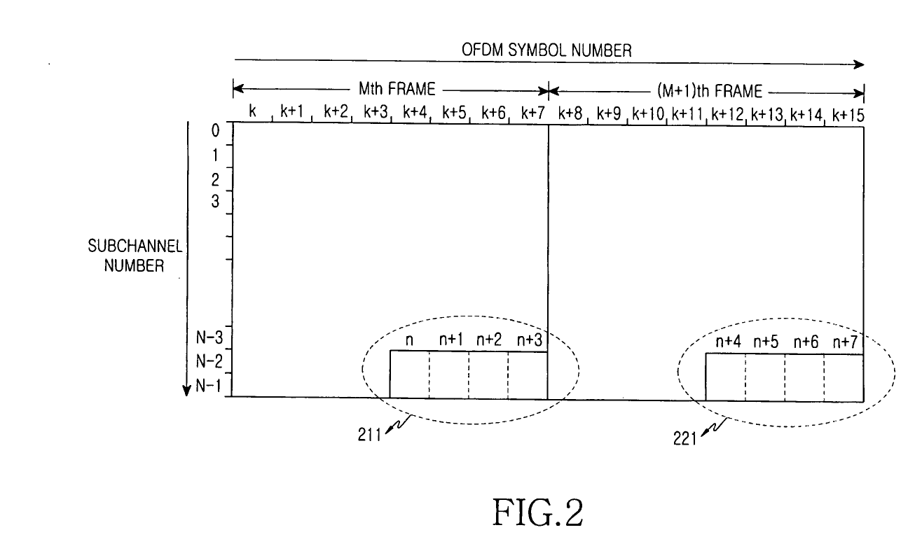

In the following description, it will be assumed that the OFDMA communication system is identical in configuration to the IEEE 802.16a communication system of FIG. 1 described in the Related Art section, and the OFDMA frame is also identical in configuration to the OFDMA frame of FIG. 2 described in the Related Art section. Also, the present invention can be applied to an IEEE 802.16e communication system that takes into consideration the mobility of a subscriber station in the IEEE 802.16a communication system. In the present invention, a ranging region configuration is divided into a scheduled access region and a random access region to efficiently perform the bandwidth request ranging.

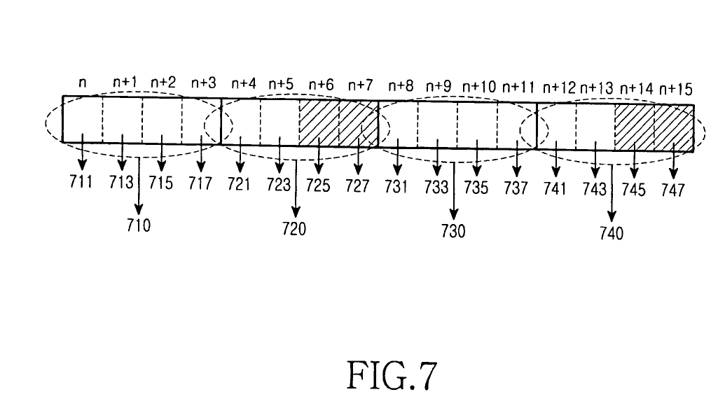

FIG. 7 is a diagram illustrating a ranging region configuration for an OFDMA communication system according to an embodiment of the present invention.

Before a description of FIG. 7 is given, it should be noted that ranging regions illustrated in FIG. 7 are identical to the ranging regions described in connection with FIG. 2. However, the ranging regions in FIG. 7 are divided into scheduled access regions and random access regions, each of which are differently used according to an operational state of a subscriber station that performs the bandwidth request ranging described blow. That is, a state of a subscriber station capable of performing the bandwidth request ranging using the ranging slots in the scheduled access region, or the scheduled access ranging slots, corresponds to a Busy state and a Hold state, while a state of a subscriber station capable of performing the bandwidth request ranging using the ranging slots in the random access region, or random access ranging slots, corresponds to an Idle state and an Access state. When the initial ranging is performed, the scheduled access ranging slots cannot be used and only the random access ranging slots can be used. The state of a subscriber station and the bandwidth request ranging operation according to a state of a subscriber station will be described herein below.

Referring to FIG. 7, reference numeral 710 represents a ranging region existing in a frame #M of the OFDMA communication system, reference numeral 720 represents a ranging region existing in a frame #(M+1) of the OFDMA communication system, reference numeral 730 represents a ranging region existing in a frame #(M+2) of the OFDMA communication system, and reference numeral 740 represents a ranging region existing in a frame #(M+3) of the OFDMA communication system. There are provided a plurality of, for example 8, OFDMA frames, and each OFDMA symbol is comprised of a plurality of, for example N, subchannels. The “subchannel” means a channel comprised of a plurality of subcarriers, and in the OFDMA communication system, each subchannel is comprised of a predetermined number of subcarriers according to the system conditions. In FIG. 7, only the ranging regions in the frames are separately illustrated, for simplicity. Although the ranging regions of only 4 frames are illustrated in FIG. 7, the frame configuration and the ranging region configuration are consecutive.

It is assumed in FIG. 7 that there are provided 4 ranging slots per ranging region. In addition, as described above, the ranging regions are divided into scheduled access regions and random access regions. In FIG. 7, non-hatched ranging slots, i.e. an n^{th} ranging slot 711 to an (n+5)^{th} ranging slot 723 and an (n+8)^{th} ranging slot 731 to an (n+13)^{th} ranging slot 743, correspond to scheduled access regions, or scheduled access ranging slots, while hatched ranging slots, i.e. an (n+6)^{th} ranging slot 725, an (n+7)^{th} ranging slot 727, an (n+14)^{th} ranging slot 745, and an (n+15)^{th} ranging slot 747, correspond to random access regions, or random access ranging slots. Although the random access ranging slots are regularly located in case of FIG. 7, the random access ranging slots can also be randomly located in the OFDMA communication system.

A state of a subscriber station capable of performing bandwidth request ranging is restricted differently in the scheduled access region and the random access region. A maximum access delay time guaranteed by the bandwidth request ranging is also different in the scheduled access region and the random access region.

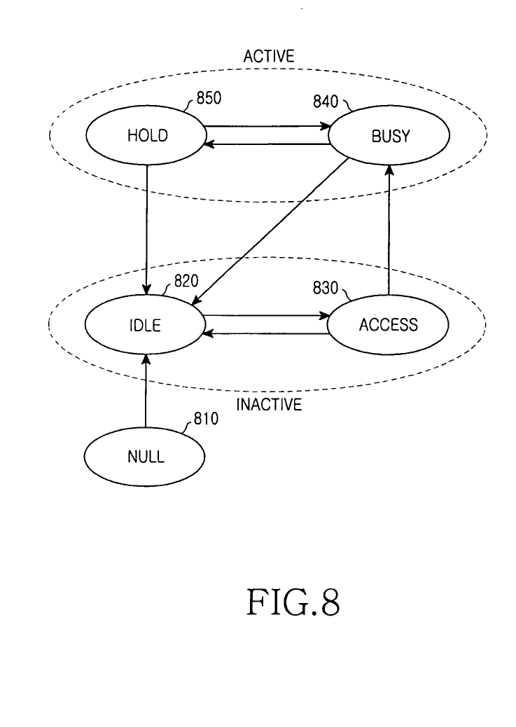

With reference to FIG. 8, a description will now be made of a subscriber station state diagram proposed in the present invention to support the bandwidth request ranging for minimizing the access delay time and preventing ranging code collision.

FIG. 8 is a diagram illustrating a state diagram of a subscriber station according to an embodiment of the present invention. Referring to FIG. 8, a state configuration of a subscriber station proposed in the present invention includes five states of a Null state 810, an Idle state 820, an Access state 830, a Busy state 840, and a Hold state 850.

1. Null State

If a subscriber station is powered on, or if the subscriber station is handed off to a new cell, or a new base station (BS), then the subscriber station monitors all of the frequency bands previously set therein and detects a pilot channel signal the having highest power level, for example a highest carrier to interference and noise ration (CINR). Because the IEEE 802.16a communication system does not take into consideration the mobility of the subscriber station, only considers power-on of the subscriber station. Because the IEEE 802.16e communication system considers the mobility of a subscriber station, it must also consider not only the power-on of the subscriber station but also the handoff of the subscriber station. Therefore, the present invention considers both power-on of the subscriber station and handoff of the subscriber station.

The subscriber station determines which base station transmits a pilot channel signal having the highest CINR as a base station to which it currently belongs. Subsequently, the subscriber station acquires the system synchronization with the base station by receiving a preamble of a downlink frame transmitted from the base station. Such a state where the subscriber station has acquired only the system synchronization with the base station and an initial ranging has not been performed yet is called the Null state 810. If an initial ranging request has occurred, the subscriber station performs the initial ranging in the Null state 810. If the subscriber station succeeds in the initial ranging, the subscriber station makes a state transition from the Null state 810 to the Idle state 820. In contrast, if the subscriber station fails in the initial ranging, the subscriber station remains in the Null state 810.

2. Idle State

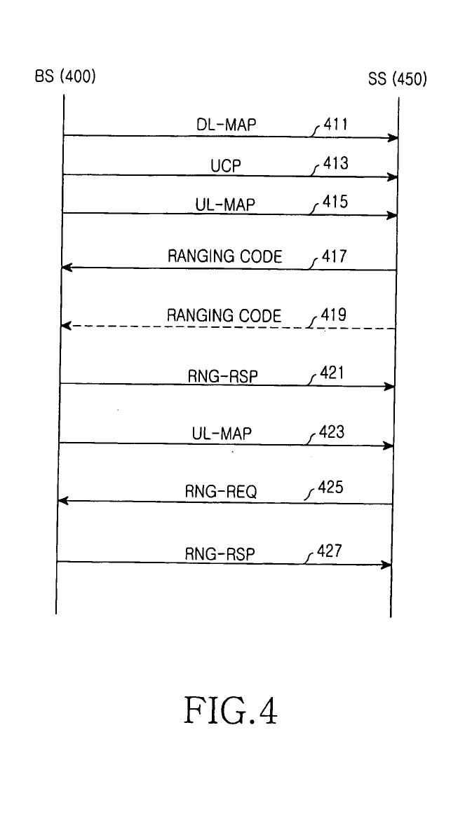

The subscriber station makes a state transition to the Idle state 820 if it succeeds in the initial ranging in the Null state 810. In the Idle state 820, because the subscriber station has succeeded in the initial ranging, the subscriber station, as described in conjunction with FIG. 4, is allocated its connection ID (CID), i.e. a basic ID and a primary management ID. Such a state where the subscriber station succeeds in the initial ranging and is allocated a basic CID and a primary management CID is called the Idle state 820. Subsequently, if the subscriber station has data to transmit to the base station in the Idle state 820, i.e. if the subscriber station needs an uplink bandwidth, the subscriber station makes a state transition to the Access state 830.

3, Access State

If the subscriber station needs an uplink bandwidth in the Idle state 820, i.e. if a bandwidth request ranging request has occurred, the subscriber station makes a state transition to the Access state 830. In the Access state 830, the subscriber station performs the bandwidth request ranging. If the subscriber station succeeds in the bandwidth request ranging, the subscriber station makes a state transition from the Access state 830 to the Busy state 840. In contrast, if the subscriber station fails in the bandwidth request ranging, the subscriber station makes a state transition from the Access state 830 to the Idle state 820. The bandwidth request ranging performed in the Access state 830 is a random access-based bandwidth request ranging. The “random access-based bandwidth request ranging” refers to a bandwidth request ranging in which the subscriber station, as described above, uses random access ranging slots and also randomly selects and transmits the ranging codes. The random access-based bandwidth request ranging randomly selects the transmission ranging slots and also randomly selects the ranging codes, thereby causing possible collision. In this case, backoff is performed by the above-described exponential random backoff algorithm.

The exponential random backoff algorithm will be described herein below.

If a minimum window size and a maximum window size used in the exponential random backoff algorithm are defined as MIM_WIN and MAX_WIN, respectively, the subscriber station randomly selects one ranging slot from among 2^{MIN}^{_{—}}^{WIN} ranging slots during first ranging code transmission, and transmits a ranging code for the selected ranging slot. If ranging code collision occurs during the first ranging code transmission, the subscriber station again randomly selects one ranging slot from among the following (2^{MIN}^{_{—}}^{WIN+1}) ranging slots from the corresponding ranging slot during second ranging code transmission, and transmits a ranging code for the selected ranging slot. If ranging code collision occurs during the second ranging code transmission, the subscriber station randomly again selects one ranging slot from among the following (2^{MIN}^{_{—}}^{WIN+2}) ranging slots from the corresponding ranging slot during third ranging code transmission, and transmits a ranging code for the selected ranging slot. In this way, when a subscriber station randomly selects one ranging slot from 2^{k} ranging slots, the ‘k’ is defined as a window size. The window size k used during the ranging code retransmission process is increased one by one from MIN_WIN until the ranging code transmission is successful, i.e. until an RNG-RSP message is received, and window size k is increased until it reaches the maximum window size MAX_WIN.

If the subscriber station fails in the bandwidth request ranging even after performing the backoff until the window size reaches the maximum window size MAX_WIN, the subscriber station makes a state transition from the Access state 830 to the Idle state 820. In conclusion, the Access state 830 is a state supporting only the random access-based bandwidth request ranging.

4. Busy State

As the subscriber station succeeds in the bandwidth request ranging in the Access state 830, the subscriber station is allocated an uplink bandwidth for data transmission. The state in which the subscriber station is allocated an uplink bandwidth for data transmission is called the Busy state 840. For the subscriber station in the Busy state 840, the base station supports a scheduled access-based bandwidth request ranging. The “scheduled access-based bandwidth request ranging” refers to bandwidth request ranging in which the subscriber station, as described above, uses scheduled access ranging slots and also transmits ranging codes using predetermined ranging codes. The scheduled access-based bandwidth request ranging classifies the subscriber stations into a plurality of groups and uniquely allocates the ranging codes to the groups, thereby preventing an access delay due to a ranging code collision and a backoff. A method for allocating the ranging codes according to the scheduled access-based bandwidth request ranging will be described herein below.

In the Busy state 840, the subscriber station transmits the data through the scheduled access-based bandwidth request ranging, and after the completion of the data transmission, the subscriber station makes a state transition from the Busy state 840 to the Hold state 850. However, in the Busy state 840, if the scheduled access-based bandwidth request ranging for the subscriber station cannot be supported, i.e. if ranging codes used for the scheduled access-based bandwidth request ranging cannot be allocated, the subscriber station makes a state transition from the Busy state 840 to the Idle state 820. An operation performed when the scheduled access-based bandwidth request ranging cannot be supported will also be described herein below.

In the Busy state 840, additional bandwidth request is possible through transmission of additionally requested bandwidth information through a previously allocated uplink bandwidth in addition to the scheduled access-based bandwidth request ranging. The transmission of the additionally requested bandwidth information can be achieved through a Poll-Me (PM) bit or a Piggyback Request field in a Grant Management subheader from among the MAC subheaders in a MAC message transmitted from the subscriber station to the base station. That is, if the subscriber station sets the PM bit to ‘1’ before transmitting it to the base station, the base station allocates an uplink bandwidth at which the subscriber station can transmit a Bandwidth_Request_IE. Then the subscriber station requests an uplink bandwidth necessary for transmitting the data through the Bandwidth_Request_IE. In addition, the transmission of the additionally requested bandwidth can be achieved through the Piggyback Request field in addition to the PM bit, and the Piggyback Request field is used for transmitting information on the number of bytes of the uplink bandwidth that is additionally requested by the subscriber station.

5. Hold State

The Hold state 850 represents a state in which the subscriber station has no more transmission data after the completion of a data transmission in the Busy state 840 and is not allocated an uplink bandwidth from the base station. Although no uplink bandwidth is actually allocated, the Hold state 850 also supports the scheduled access-based bandwidth request ranging. That is, in the Hold state 850, if the subscriber station has data to transmit to the base station, the subscriber station is allocated an uplink bandwidth for the data transmission by performing the scheduled access-based bandwidth request ranging. The subscriber station, as it is allocated the uplink bandwidth, makes a state transition from the Hold station 850 to the Busy state 840. The Hold state 850 also performs the scheduled access-based bandwidth request ranging, thereby preventing an access delay due to a ranging code collision and a backoff.

In the Hold state 850, if there is no data to be transmitted from the subscriber station to the base station for a predetermined time (Time Out), the subscriber station makes a state transition from the Hold state 850 to the Idle state 820. As the subscriber station makes a state transition from the Hold state 850 to the Idle state 820, the subscriber station releases a group ID and a ranging code which were allocated to support the scheduled access-based bandwidth request ranging.

Of the 5 states described above, the Idle state 820 and the Access state 830 correspond to an Inactive state in which only the random access-based bandwidth request ranging is supported, i.e. the scheduled access-based bandwidth request ranging is inactivated. Meanwhile, the Busy state 840 and the Hold state 850 correspond to an Active state in which the scheduled access-based bandwidth request ranging is activated. In conclusion, the subscriber stations in the Active state support the scheduled access-based bandwidth request ranging, thereby reducing an access delay time and optimizing the performance of the OFDMA communication system.

The scheduled access-based bandwidth request ranging will be described herein below.

In order to support the scheduled access-based bandwidth request ranging in the Active state, i.e. the Busy state 840 and the Hold state 850, it is necessary to classify the subscriber stations into a plurality of groups and allocate unique ranging codes to the subscriber stations belonging to each of the groups. A method of grouping the subscriber stations and allocating the unique ranging codes to subscriber stations in each group will be described herein below.

It will be assumed that the number of groups into which subscriber stations are classified is G and the number of ranging codes available in each ranging slot is C. Because the number of groups is G, the number of the group IDs is also G, and C ranging codes are uniquely allocated to each of the G groups. If the number of groups is G, the number of ranging slots existing in one frame is also G. That is, as many ranging slots as the number of groups must be allocated for the scheduled access-based bandwidth request ranging. For example, in FIG. 7, because the number of scheduled access ranging slots is 6, the number of groups becomes 6.

The number of subscriber stations available in the Active state, or the Busy state 840 and the Hold state 850, becomes G*C. That is, G*C subscriber stations have different group IDs and ranging codes, and if a bandwidth request ranging is performed such that the subscriber stations have different group IDs and ranging codes, ranging code collision is prevented, contributing to minimization of an access delay time.

In FIG. 8, if a subscriber station makes a state transition to the Busy state 840, a base station informs the subscriber station of a group ID indicating a group to which the subscriber station belongs and a ranging code allocated to the subscriber station in its group. The base station manages the group ID and ranging code using CIDs, i.e. basic CID and primary management CID, of the subscriber station.

In the state where the number of subscriber stations existing in the Busy state 840 and the Hold state 850 is G*C, if a particular subscriber station desires to make a state transition to the Busy state 840 or the Hold state 850, it is not possible to allocate a ranging code for the scheduled access-based bandwidth request ranging. Therefore, the state transition is unavailable until there is a free ranging code. When there are no unused group IDs and ranging codes, the base station can perform the following 2 operations.

In a first operation, because there are no unused group IDs and ranging code, the base station does not allow a subscriber station desiring to make a state transition to the Busy state 840 or the Hold state 850 to make the state transition, and makes the subscriber station wait until there is a free group ID and a ranging code. That is, the base station waits until there is a subscriber station desiring to make a state transition to the Idle state 820 from among the subscriber stations existing in the Busy state 840 and the Hold state 850. The base station allocates a group ID and a ranging code released from a subscriber station that made a state transition to the Idle state 820, to a subscriber station desiring to make a state transition to the Busy state 840 or the Hold state 850, thereby enabling the state transition.

In a second operation, because there are no unused group IDs and ranging codes, the base station releases group IDs and ranging codes previously allocated to subscriber stations existing in the Busy state 840 and the Hold state 850, and allocates a released group ID and a ranging code to a subscriber station desiring to make a state transition to the Busy state 840 or the Hold state 850, thereby enabling the state transition. For example, in some cases, the priority of the Quality-of-Service (QoS) guaranteed by the subscriber station desiring to make a new state transition to the Busy state 840 or the Hold state 850 is greater than QoS priority of subscriber stations currently existing in the Busy state 840 and the Hold state 850. As another example, the base station releases a group ID and a ranging code of a subscriber station existing longest in the Hold state 850, i.e. a subscriber station having the lowest data transmission frequency, from among the subscriber stations currently existing in the Busy state 840 and the Hold state 850, and allocates the released group ID and ranging code to a subscriber station desiring to make a new state transition to the Busy state 840 or the Hold state 850, thereby enabling the state transition. The subscriber station whose group ID and ranging code were released by the base station makes a state transition to the Idle state 820.

An operation of the base station for the case where there are no unused group IDs and ranging codes has been described so far. Next, a description will be made of an operation of allocating a group ID and a ranging code when there is a free group ID and a ranging code.

When there is a free group ID and a ranging code, the base station randomly selects one group ID and one ranging code among the free group IDs and their associated ranging codes, and allocates the selected group ID and ranging code to a subscriber station desiring to make a new state transition to the Busy state 840 or the Hold state 850, thereby enabling state transition.

Alternatively, the base station selects a group having the minimum number of subscriber stations to which the ranging codes in a group are allocated from among the free group IDs and their associated ranging codes, and allocates a ranging code in the group to a subscriber station desiring to make a new state transition to the Busy state 840 or the Hold state 850, thereby enabling the state transition. In this case, it is possible to equally maintain the number of subscriber stations allocated ranging codes in each group, i.e. the number of subscriber stations supporting the scheduled access-based bandwidth request ranging.

In the foregoing description, the subscriber stations existing in the Busy state 840 or the Hold state 850 should be able to identify the group IDs and the ranging codes allocated thereto in order to perform the scheduled access-based bandwidth request ranging. Therefore, the base station periodically broadcasts the mapping information of the group IDs and ranging slots, and also informs the subscriber stations existing in the Busy state 840 or the Hold state 850 of the group IDs and ranging codes allocated thereto. The group IDs and ranging codes can be transmitted through previously proposed messages or newly proposed messages. Even when the previously allocated group IDs and ranging codes are released, the information must be provided to the corresponding subscriber stations.

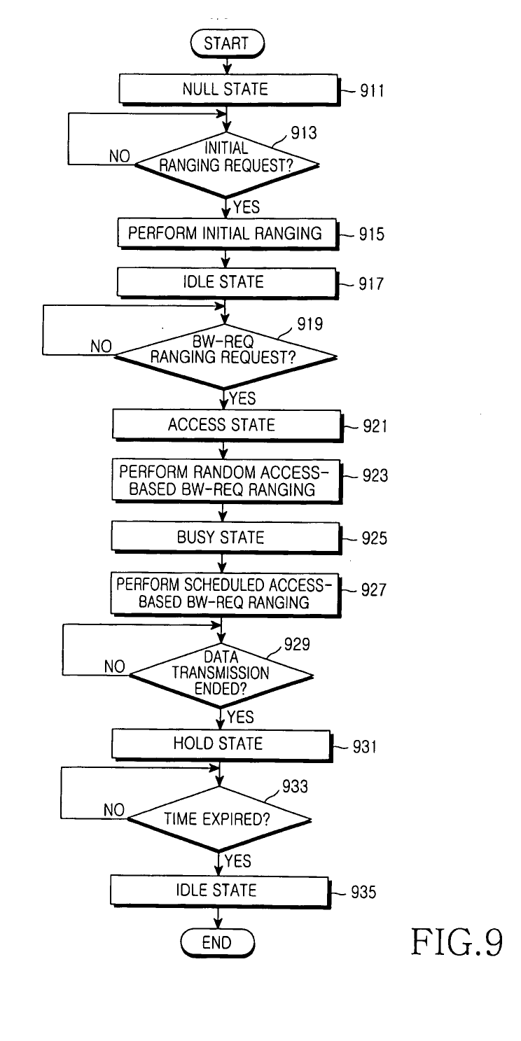

FIG. 9 is a flowchart illustrating a ranging procedure by a subscriber station in an OFDMA communication system according to an embodiment of the present invention. Referring to FIG. 9, a subscriber station existing in a Null state in step 911 determines in step 913 if an initial ranging request has occurred. If it is determined that an initial ranging request has occurred, the subscriber station proceeds to step 915. In step 915, the subscriber station performs the initial ranging, and then proceeds to step 917. Here, the initial ranging, as described above, is random access-based ranging, and during the initial ranging, the subscriber station randomly selects a random ranging slot from among the ranging slots allocated for the initial ranging, and randomly selects a random ranging code from among the ranging codes allocated for the initial ranging. Thereafter, the subscriber station performs the initial ranging at the randomly selected ranging slot using the randomly selected ranging code.

In step 917, if the subscriber station succeeds in the initial ranging, the subscriber station makes a state transition to an Idle state, and then proceeds to step 919. However, if the subscriber station fails in the initial ranging, the subscriber station remains in the Null state. In step 919, the subscriber station determines if a bandwidth request ranging request has occurred. The occurrence of the bandwidth request ranging request means that a bandwidth is requested as there is data to be transmitted from the subscriber station to the base station. If it is determined that a bandwidth request ranging request has occurred, the subscriber station proceeds to step 921. In step 921, the subscriber station makes a state transition from the Idle state to an Access state as the bandwidth request ranging request has occurred, and then proceeds to step 923. In step 923, the subscriber station performs random access-based bandwidth request ranging, and then proceeds to step 925. Here, the subscriber station detects the ranging slots allocated for the random access-based bandwidth request ranging from among the ranging slots allocated for the bandwidth request ranging. Thereafter, the subscriber station randomly selects a random ranging slot from among the ranging slots allocated for the random access-based bandwidth request ranging, and randomly selects a random ranging code from among the ranging codes allocated for the bandwidth request ranging. Thereafter, the subscriber station performs the random access-based bandwidth request ranging at the randomly selected ranging slot using the randomly selected ranging code.

In step 925, the subscriber station makes a state transition from the Access state to a Busy state as it succeeds in the random access-based bandwidth request ranging, and then proceeds to step 927. However, if the subscriber station fails in the random access-based bandwidth request ranging, the subscriber station remains in the Access state. In step 927, the subscriber station performs scheduled access-based bandwidth request ranging, and proceeds to step 929. Here, the subscriber station performs the scheduled access-based bandwidth request ranging using a group ID and a ranging code received from a base station. The base station generates as many groups as the number of ranging slots allocated for the scheduled access-based bandwidth request ranging from among the ranging slots allocated for the bandwidth request ranging. Further, the base station uniquely allocates ranging codes allocated for the bandwidth request ranging in the groups, and if the base station detects that the subscriber station has succeeded in the random access-based bandwidth request ranging, the base station selects a random group from among the groups and selects a random ranging code from among the ranging codes in the selected group. Thereafter, the base station transmits a group ID corresponding to the selected group and the selected ranging code to the subscriber station. Then the subscriber station performs the scheduled access-based bandwidth request ranging at a ranging slot corresponding to the group ID using the selected ranging code, thereby reducing an access delay due to ranging code collision and backoff.

In step 929, the subscriber station determines if the data transmission is ended while performing the data transmission through the allocated bandwidth. If it is determined that the data transmission is ended, the subscriber station proceeds to step 931. In step 931, the subscriber station makes a state transition from the Busy state to a Hold state, and then proceeds to step 933. In step 933, the subscriber station determines if a predetermined time has elapsed. Here, the reason for determining if a predetermined time has elapsed is as follows. When a subscriber station waits for a predetermined time in the Hold state without performing the bandwidth request ranging, it is necessary to release a group ID and a ranging code allocated to the subscriber station existing in the Hold state for efficient scheduled access-based bandwidth request ranging.

If it is determined that the predetermined time has elapsed, the subscriber station proceeds to step 935. In step 935, the subscriber station makes a state transition from the Hold state to an Idle state, and then ends the procedure.

As can be understood from the foregoing description, the present invention provides a ranging method for minimizing an access delay and preventing ranging code collision by adaptively performing a bandwidth request ranging based on a scheduled access technique or a random access technique according to a state of a subscriber station. In particular, the ranging method allows the subscriber stations existing in an Active state to preferentially perform a scheduled access-based bandwidth request ranging, thereby preventing an access delay due to a ranging code collision and maximizing data transmission efficiency.

While the invention has been shown and described with reference to a certain preferred embodiment thereof, it will be understood by those skilled in the art that various changes in form and details may be made therein without departing from the spirit and scope of the invention as defined by the appended claims.

1. A method for controlling an operational state of at least one subscriber station in an Orthogonal Frequency Division Multiplexing/Orthogonal Frequency Division Multiple Access (OFDM/OFDMA) wireless communication system having ranging slots and ranging codes to be used for rangings, the method comprising the steps of:
performing, by the subscriber station in a Null state, an initial ranging if an initial ranging request occurs, and transitioning from the Null state to an Idle state if the initial ranging is successful;
transitioning to an Access state if a bandwidth request ranging request occurs in the Idle state, and performing in the Access state the bandwidth request ranging based on a random access technique;
transitioning from the Access state to a Busy state if the random access-based bandwidth request ranging is successful, performing the bandwidth request ranging based on a scheduled access technique if the bandwidth request ranging request occurs in the Busy state, and transmitting data if the scheduled access-based bandwidth request ranging is successful; and
transitioning to a Hold state if the data transmission is ended in the Busy state, and performing the scheduled access-based bandwidth request ranging if the bandwidth request ranging request occurs in the Hold state.

2. The method of claim 1, further comprising the step of transitioning to the Busy state if the scheduled access-based bandwidth request ranging is successful in the Hold state.

3. The method of claim 1, further comprising the step of transitioning to the Idle state if the bandwidth request ranging request does not occur for a preset period of time in the Hold state.

4. The method of claim 1, further comprising the step of transitioning to the Idle state if the scheduled access-based bandwidth request ranging fails in the Busy state.

5. The method of claim 1, further comprising the step of waiting in the Null state if the initial ranging fails.

6. The method of claim 1, wherein the step of performing the scheduled access-based bandwidth request ranging comprises the step of performing a bandwidth request ranging at a ranging slot corresponding to a group identifier (ID) received from a base station, using a ranging code mapped to the group ID and received from a base station.

7. The method of claim 6, wherein the group ID and the ranging code mapped to the group ID are allocated by the base station, and the base station generates a number of groups equal to the number of ranging slots allocated for the scheduled access-based bandwidth request ranging from among the ranging slots, allocates the ranging codes such that the ranging codes are not duplicated in each of the groups, allocates a random group from among the groups to a subscriber station that has succeeded in the random access-based bandwidth request ranging, and allocates a random ranging code from among the ranging codes in the random group.

8. The method of claim 7, wherein the group ID and the ranging code mapped to the group ID are allocated according to a connection ID that is allocated when the initial ranging is successful.

9. The method of claim 1, wherein the step of performing the random access-based bandwidth request ranging comprises the step of selecting a random ranging slot from among ranging slots allocated for the random access-based bandwidth request ranging in ranging slots for the bandwidth request ranging, selecting a random ranging code from among ranging codes for the bandwidth request ranging, and performing bandwidth request ranging at the selected ranging slot using the selected ranging code.

10. A ranging method for minimizing an access delay of subscriber stations and preventing a ranging code collision in a wireless communication system having ranging slots and ranging codes to be used for rangings, the rangings between a base station and a subscriber station being classified into an initial ranging, a bandwidth request ranging and a periodic ranging, the ranging method comprises the steps of:
performing, by the subscriber station, an initial ranging with the base station;
performing, by the subscriber station, a bandwidth request ranging based on a random access technique with the base station if the initial ranging is successful; and
performing, by the subscriber station, the bandwidth request ranging based on a scheduled access technique with the base station if the random access-based bandwidth request ranging is successful.

11. The ranging method of clam 10, wherein the step of performing the bandwidth request ranging based on a scheduled access technique comprises the steps of:
generating, by the base station, as many groups as the number of ranging slots allocated for the scheduled access-based bandwidth request ranging from among the ranging slots, and allocating the ranging codes such that ranging codes for the bandwidth request ranging are not duplicated in each of the groups;
selecting, by the base station, a random group from among the groups if the random access-based bandwidth request ranging by the subscriber station is successful, selecting a random ranging code from among ranging codes in the selected group, and transmitting a group identifier (ID) corresponding to the selected group and the selected ranging code to the subscriber station; and
performing, by the subscriber station, a bandwidth request ranging at a ranging slot corresponding to the group ID using the selected ranging code.

12. The ranging method of claim 10, wherein the base station selects the group ID and the ranging code according to a connection ID that is allocated to the subscriber station as the initial ranging by the subscriber station is successful.

13. The ranging method of claim 10, wherein the step of performing the bandwidth request ranging based on a random access technique comprises the steps of:
selecting, by the subscriber station, a random ranging slot from among ranging slots allocated for the random access-based bandwidth request the ranging in ranging slots for the bandwidth request ranging, and selecting a random ranging code from among ranging codes for the bandwidth request ranging; and
performing, by the subscriber station, a bandwidth request ranging at the selected ranging slot using the selected ranging code.

14. A ranging method for minimizing an access delay of subscriber stations and preventing a ranging code collision in a wireless communication system having ranging slots and ranging codes to be used for rangings, the rangings between a base station and a subscriber station being classified into an initial ranging, a bandwidth request ranging and a periodic ranging, the ranging method comprises the steps of:
generating, by the base station, a number of groups equal to the number of ranging slots allocated for a bandwidth request ranging based on a scheduled access technique from among the ranging slots for the bandwidth request ranging, and allocating the ranging codes such that ranging codes for the bandwidth request ranging are not duplicated in each of the groups;
performing, by the subscriber station, the initial ranging with the base station;
selecting, by the subscriber station, a random ranging slot from among the ranging slots allocated for the bandwidth request ranging based on a random access technique in the ranging slots for the bandwidth request ranging if the initial ranging is successful, and selecting a random ranging code from among the ranging codes for the bandwidth request ranging;
performing, by the subscriber station, the random access-based bandwidth request ranging at the selected ranging slot using the selected ranging code;
selecting, by the base station, a random group from among the groups if the random access-based bandwidth request ranging by the subscriber station is successful, selecting a random ranging code from among the ranging codes in the selected group, and transmitting a group identifier (ID) corresponding to the selected group and the selected ranging code to the subscriber station; and
performing, by the subscriber station, the scheduled access-based bandwidth request ranging at a ranging slot corresponding to the group ID using the selected ranging code.

15. The ranging method of claim 14, wherein the base station selects the group ID and the ranging code according to a connection ID that is allocated to the subscriber station when the initial ranging by the subscriber station is successful.
